(19) United States
(12) Patent Application Publication
(10) Pub. No.: US 2006/0126448 A1
(43) Pub. Date: Jun. 15, 2006

(54) Disk reproducing method, control program thereof, recording medium, disk reproducing apparatus, and optical disk-purpose signal processing circuit

(76) Inventors: Satoshi Ogata, Ichikawa-shi (JP); Yuuichiro Nakamura, Tokyo (JP)

Correspondence Address: MCDERMOTT WILL & EMERY LLP, 600 13TH STREET, N.W., WASHINGTON, DC, 20005-3096, US

(21) Appl. No.: 11/285,765

(22) Filed: Nov. 23, 2005

(30) Foreign Application Priority Data
Nov. 26, 2004 (JP) P2004-341798
Sep. 12, 2005 (JP) P2005-263840

(51) Int. Cl. G11B 11/00

(52) U.S. Cl. 369/13.02; 369/44.27

(57) ABSTRACT

In a disk reproducing apparatus for selecting data which is reproduced in response to a reproduction environment from a disk in which data whose reproducing systems are different from each other have been recorded in different areas of the disk, a reproduction switching means 100 is provided so as to detect an occurrence of a reproduction error as to the selected data, and switch a reproducing operation for the selected data to a reproducing operation for such data whose reproducing system is different from that of the selected data.

### BACKGROUND OF THE INVENTION

1. Field of the Invention

The present invention is related to a disk reproducing method, a control program thereof, a recording medium, a disk reproducing apparatus, and an optical disk-purpose signal processing circuit.

2. Description of the Related Art

Recently, 5.1-channel multichannel audio systems have been rapidly popularized since home theater systems and the like are commercially available. On the other hand, audio reproducing needs for conventionally used 2-channel stereophonic audio systems are still strongly present. Under such a circumstance, technical specification such as the DVD-Audio specification capable of accepting such a difference between these audio systems with respect to users have been proposed. In this DVD-Audio specification, two sorts of audio data have been recorded on the same optical disk, while reproducing systems of these audio data are different from each other (namely, multichannel reproducing system and stereophonic reproducing system) as to the same music. Therefore, optimum audio data can be reproduced in correspondence with audio systems used by users (refer to, for example, JP11-296998-A (pages 9 to 33, FIG. 1)).

On the other hand, in optical disks, if disk planes on which audio data have been recorded are scratched, then audio data cannot be read out from the scratched recording plane and thus cannot be reproduced. Also, in the case that audio data correspond to digital data, if abnormal conditions, dropouts, and the like are present in these digital data, then these digital data cannot be reproduced.

### SUMMARY OF THE INVENTION

The present invention has been made to solve the above-explained problems of the prior art, and therefore, has an object to provide a disk reproducing method, a control program thereof, a recording medium, a disk reproducing apparatus, and an optical disk-purpose signal processing circuit, by which even in such a disk plane that reproducing operation was conventionally interrupted, or could not be conventionally carried out due to an occurrence of reproduction errors, reproducing operation of this disk plane can be continuously carried out.

A disk reproducing method of the present invention is featured by such a disk reproducing method for selecting data which is reproduced in response to a reproduction environment from a disk in which data whose reproducing systems are different from each other have been recorded in different areas of the disk, comprising: a reproduction switching step for detecting an occurrence of a reproduction error as to the selected data and for switching the reproducing operation for the selected data to a reproducing operation for data whose reproducing system is different from the reproducing system of the selected data.

In accordance with the above-explained arrangement, the occurrence of the reproduction error as to the selected data is detected, and then, the reproducing operation of the selected data is changed into the reproducing operation for the data whose reproducing system is different from that of the selected data. As a result, since the reproduction error occurs, the reproduction of the audio data was conventionally interrupted and/or the audio data could not be reproduced. However, even such an audio data portion can be continuously reproduced.

Also, the disk reproducing method of the present invention is featured by that the reproduction switching means detects passing of an occurring position of the reproduction error, and then switches the present reproducing operation to the reproducing operation for the data which was reproduced before the switching operation. In accordance with the above-described arrangement, even when the reproducing operation is carried out by switching the present data into such a data recorded by a different reproducing system, after the occurrence position of the error has passed, the present reproducing operation is recovered to the reproducing operation for the original data. As a result, the disk can be reproduced based upon the original data except for the error portion while the reproducing operation is not interrupted.

Also, the disk reproducing method of the present invention is featured by that the reproduction switching means detects a completion of a reproducing operation of a track, and then switches the present reproducing operation to the reproducing operation for the data which was reproduced before the switching operation. In accordance with the above-described arrangement, the present reproducing operation is switched to the reproducing operation for the data recorded in the different reproducing system only in such a track that the error portion is contained, and the reproducing operation is recovered to the reproducing operation for the original data in the tracks other than the above track. As a result, the disk can be reproduced based upon the original data in any tracks other than the track containing the error portion while the reproducing operation is not interrupted.

Also, the disk reproducing method of the present invention is featured by that the reproduction switching means detects a reproduction error as to selected stereophonic reproducing type data, and then switches the reproducing operation for the stereophonic reproducing type data into a reproducing operation for multichannel reproducing type data by way of a down-mix process operation. In accordance with the above-described arrangement, in such a case that while the stereophonic reproducing type data is reproduced, the present reproducing operation is switched to the reproducing operation for the multichannel audio data, the down-mix process operation is carried out. As a result, even when the audio data to be reproduced is switched in a half way, the reproducing operation can be carried out in such an operation mode more suitable for a reproduction environment.

Also, the disk reproducing method of the present invention is featured by that the reproduction switching means detects a reproduction error as to selected multichannel reproducing type data, and then switches the reproducing operation for the multichannel reproducing type data into a reproducing operation for stereophonic reproducing type data by way of a multichannel expansion process operation. In accordance with the above-described arrangement, in such a case that while the multichannel reproducing type data is reproduced, the present reproducing operation is switched to the reproducing operation for the stereophonic audio data, the multichannel expansion operation is carried out. As a result, even when the audio data to be reproduced is switched in a halfway, the reproducing operation can be carried out in such an operation mode more suitable for a reproduction environment.

Also, the disk reproducing method of the present invention is featured by comprising notification means for notifying switching of reproduction data. In accordance with the above-described arrangement, since the switching operation of the reproduction data is notified, the user previously can recognize that an adverse influence is produced by switching the reproducing operations. As a result, it is possible to avoid that the user is confused.

Also, the disk reproducing method of the present invention is featured by comprising permission means for permitting that reproduction data is switched by the reproduction switching means in response to an external instruction. In accordance with the above-explained arrangement, the user can set as to whether or not the reproducing operation is switched. As a result, it is possible to avoid that the user is confused since the reproducing operation is automatically switched.

Also, a control program, according to the present invention, is featured by such a control program of a disk reproducing apparatus for selecting data which is reproduced in response to a reproduction environment from a disk in which data whose reproducing systems are different from each other have been recorded in different areas of the disk, in which the control program causes a computer to execute a reproduction switching step for detecting an occurrence of a reproduction error as to the selected data and for switching the reproducing operation for the selected data to a reproducing operation for data whose reproducing system is different from the reproducing system of the selected data.

Also, the control program of the present invention is featured by that the reproduction switching step detects passing of an occurring position of the reproduction error, and then switches the present reproducing operation to the reproducing operation for the data which was reproduced before the switching operation.

Also, the control program of the present invention is featured by that the reproduction switching step detects a completion of a reproducing operation of a track, and then switches the present reproducing operation to the reproducing operation for the data which was reproduced before the switching operation.

Also, the control program of the present invention is featured by that the reproduction switching step detects a reproduction error as to selected stereophonic reproducing type data, and then switches the reproducing operation for the stereophonic reproducing type data into a reproducing operation for multichannel reproducing type data by way of a down-mix process operation.

Also, the control program of the present invention is featured by that the reproduction switching step detects a reproduction error as to selected multichannel reproducing type data, and then switches the reproducing operation for the multichannel reproducing type data into a reproducing operation for stereophonic reproducing type data by way of a multichannel expansion process operation.

Also, the control program of the present invention is featured by that the control program causes the computer to execute a step for notifying switching of reproduction data.

Also, the control program of the present invention is featured by that the control program causes the computer to execute a step for permitting that reproduction data is switched by the reproduction switching step in response to an external instruction.

Also, a recording medium of the present invention is featured by such a recording medium which has recorded the control program of the present invention.

Also, a disk reproducing apparatus of the present invention is featured by mounting a memory which has recorded the control program of the present invention.

Also, an optical disk-purpose signal processing circuit, according to the present invention, is featured by such an optical disk-purpose signal processing circuit for selecting data which is reproduced in response to a reproduction environment from a disk in which data whose reproducing systems are different from each other have been recorded in different areas of the disk, comprising: reading means for reading data from the optical disk; audio reproducing means for demodulating audio data from the data read by the reading means; management information storage means for storing thereinto management information used to reproduce the data read by the reading means; and reproducing data control means for controlling data which is reproduced; in which the reproducing data control means is comprised of reproduction switching means for detecting an occurrence of a reproduction error as to the selected data and for switching the reproducing operation for the selected data to a reproducing operation for data whose reproducing system is different from the reproducing system of the selected data.

Also, the optical disk-purpose signal processing circuit of the present invention is featured by that the reproduction switching means detects passing of an occurring position of the reproduction error, and then switches the present reproducing operation to the reproducing operation for the data which was reproduced before the switching operation.

Also, the optical disk-purpose signal processing circuit of the present invention is featured by that the reproduction switching means detects a completion of a reproducing operation of a track, and then switches the present reproducing operation to the reproducing operation for the data which was reproduced before the switching operation.

Also, the optical disk-purpose signal processing circuit of the present invention is featured by that the reproduction switching means detects a reproduction error as to selected stereophonic reproducing type data, and then switches the reproducing operation for the stereophonic reproducing type data into a reproducing operation for multichannel reproducing type data by way of a down-mix process operation.

Also, the optical disk-purpose signal processing circuit of the present invention is featured by that the reproduction switching means detects a reproduction error as to selected multichannel reproducing type data, and then switches the reproducing operation for the multichannel reproducing type data into a reproducing operation for stereophonic reproducing type data by way of a multichannel expansion process operation.

Also, the optical disk-purpose signal processing circuit of the present invention is featured by comprising notification means for notifying switching of reproduction data.

Also, the optical disk-purpose signal processing circuit of the present invention is featured by comprising permission means for permitting that reproduction data is switched by the reproduction switching means in response to an external instruction.

Further, the disk reproducing method of the present invention is featured by that the data corresponds to audio data having a data structure standardized by the DVD-Audio specification.

In accordance with the present invention, the occurrence of the reproduction error as to the selected data is detected and the reproducing operation for the selected data is switched to the reproducing operation for the data whose reproducing system is different from the reproducing system of the selected data, so that the reproducing operation can be continuously carried out even in such a portion that the reproducing operation has been conventionally interrupted, or could not be conventionally performed due to the occurrence of the reproduction error.

### BRIEF DESCRIPTION OF THE DRAWINGS

FIG. 1 is a diagram for showing an internal arrangement of an optical disk reproducing apparatus according to an embodiment mode 1 of the present invention.

FIG. 2 is a diagram for showing a data structural example of management information used to reproduce audio data recorded on an optical disk.

FIG. 3 is a diagram for showing a detailed data structure as to ATS_PGCI_SRP.

FIG. 4 is a diagram for showing a detailed data structure as to ATS_PGCI_GI.

FIG. 5 is a diagram for showing a detailed data structure as to ATS_PGI.

FIG. 6 is a diagram for representing logic formats of audio data recorded on the optical disk.

FIG. 7 is a flow chart for describing reproducing sequential operations of the optical disk reproducing apparatus according to the embodiment mode 1 of the present invention.

FIG. 8 is a flow chart for indicating a selecting sequence of audio data to be reproduced.

FIG. 9 is a flow chart for explaining reproduction switching sequential operations of the optical disk reproducing apparatus according to the embodiment mode 1 of the present invention.

FIG. 10 is a flow chart for explaining reproduction switching sequential operations of an optical disk reproducing apparatus according to an embodiment mode 2 of the present invention.

FIG. 11 is a flow chart for explaining reproduction switching sequential operations of an optical disk reproducing apparatus according to an embodiment mode 3 of the present invention.

FIG. 12 is a flow chart for explaining process operations for optimizing reproducing operations of an optical disk reproducing apparatus according to an embodiment mode 4 of the present invention.

FIG. 13 is a flow chart for explaining reproduction switching sequential operations of an optical disk reproducing apparatus according to an embodiment mode 5 of the present invention.

FIG. 14 is a schematic diagram (interrogation for whether or not switching operation of reproducing operation is permitted) for indicating a display example to a monitor corresponding to external display means.

FIG. 15 is a schematic diagram (switching operation of reproducing operation is carried out) for indicating a display example to a monitor corresponding to external display means.

### DESCRIPTION OF THE PREFERRED EMBODIMENTS

Referring now to the accompanying drawings, a detailed description is made of a disk reproducing apparatus according to an embodiment mode of the present invention. It should be understood that while a disk standardized to the DVD-Audio specification is employed as a disk in which data has been recorded on different recording areas by way of different reproducing systems, such an optical disk reproducing apparatus for selectively reproducing the data in response to a reproduction environment will now be explained.

### Embodiment Mode 1

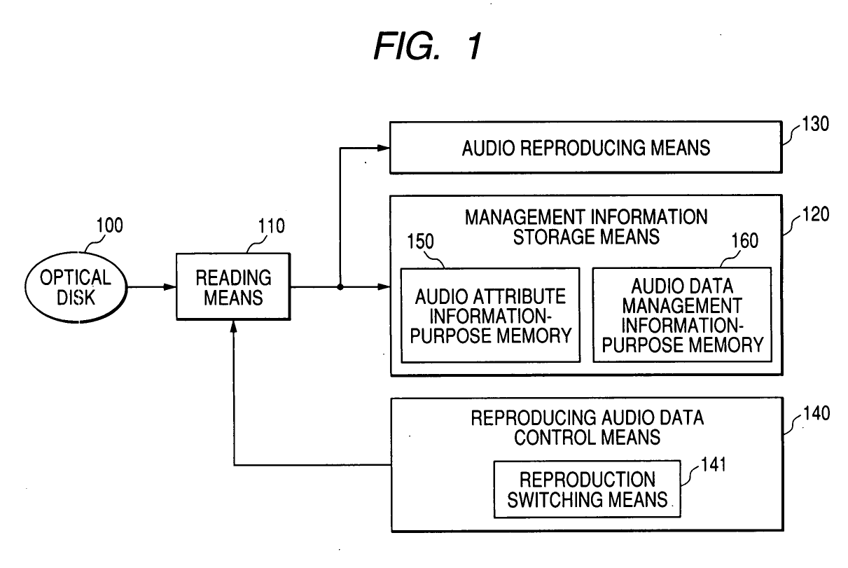

FIG. 1 is a diagram for representing an internal arrangement of an optical disk reproducing apparatus according to an embodiment mode 1 of the present invention. The optical disk reproducing apparatus is arranged by containing a reading means 110, an audio reproducing means 130, a management information storage means 120, and a reproducing audio data control means 140. The reading means 110 converts information contained in an optical disk 100 into an electric signal. The audio reproducing means 130 demodulates audio data from the information contained in the optical disk 100, which is read out by the ready means 110. The management information storage means 120 stores there into management information which is used so as to reproduce audio information from the information contained in the optical disk 100 read by the reading means 110. The reproducing audio data control means 140 controls audio data which is reproduced. The optical disk reproducing apparatus shown in FIG. 1 is arranged by further containing an optical disk-purpose signal processing circuit.

The management information storage means 120 is provided with an audio attribute information-purpose memory 150 which stores thereinto the management information used to reproduce audio information recorded on the optical disk 100, and an audio data management information purpose memory 160 for controlling audio data which is reproduced. The reproducing audio data control means 140 is equipped with a reproduction switching means 141. The reproduction switching means 141 detects an occurrence of a reproducing error of selected data, and switches the reproducing system of the selected data to a different reproducing system of data instead of the selected data. The reproduction switching means 141 monitors as to whether or not such an error portion that a reproducing operation cannot be continuously carried out is present in audio data of the optical disk 100. When such an error portion is present, the reproduction switching means 141 switches the present reproducing operation into another reproducing operation of the relevant portion of audio data formed in a different specification (namely, different reproducing system) which has been recorded in a different area within the same unit, while this error portion is not reproduced.

In this case, the management information will now be explained which has been recorded on an optical disk which is reproduced by the optical disk reproducing apparatus with employment of the above-explained arrangement.

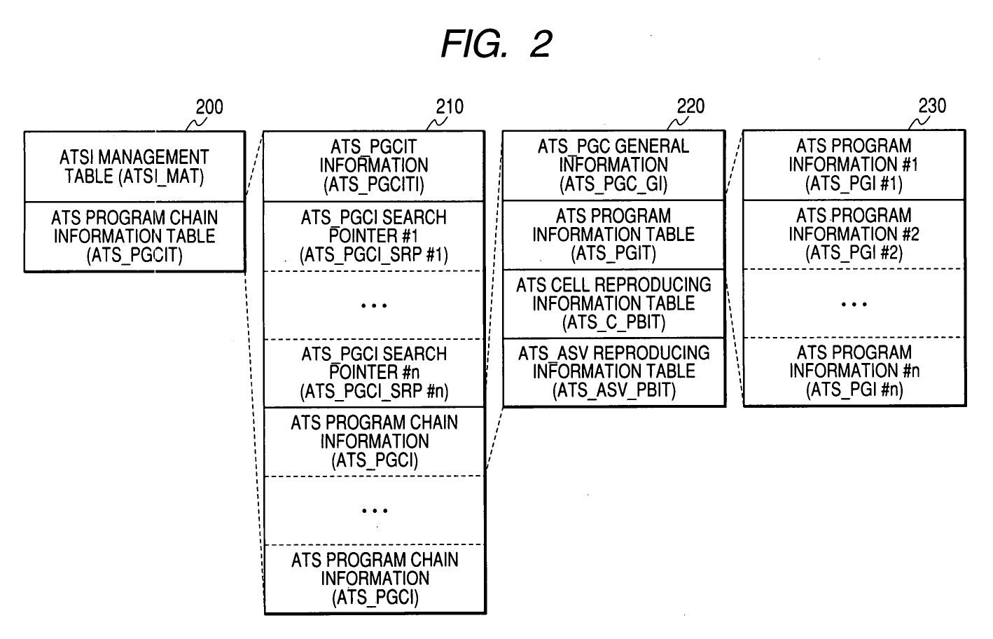

FIG. 2 is a diagram for illustratively showing a data structural example of the management information which is used so as to reproduce the audio data recorded on the optical disk. The management information is mainly constituted by an ATSI_MAT (ATSI (Audio Title Set Information) management table) 200, an ATS_PGCI_SRP (ATS_program chain information search pointer) 210, an ATS_PGC_GI (ATS_PGC general information) 220, and an ATS_PGI (ATS program information) 230, and the like. In the ATSI_MAT 200, attributes of the audio data have been recorded. In the ATS_PGCI_SRP 210, such information for indicating that two sorts of audio data with same contents belong to the same unit has been record. In the ATS_PGC_GI 220, such information for indicating that single audio data has been constituted as a plurality of tracks has been recorded. In the ATS_PGI 230, such information for indicating as to whether or not a track to be reproduced corresponds to prohibition of a stereophonic reproducing operation has been recorded.

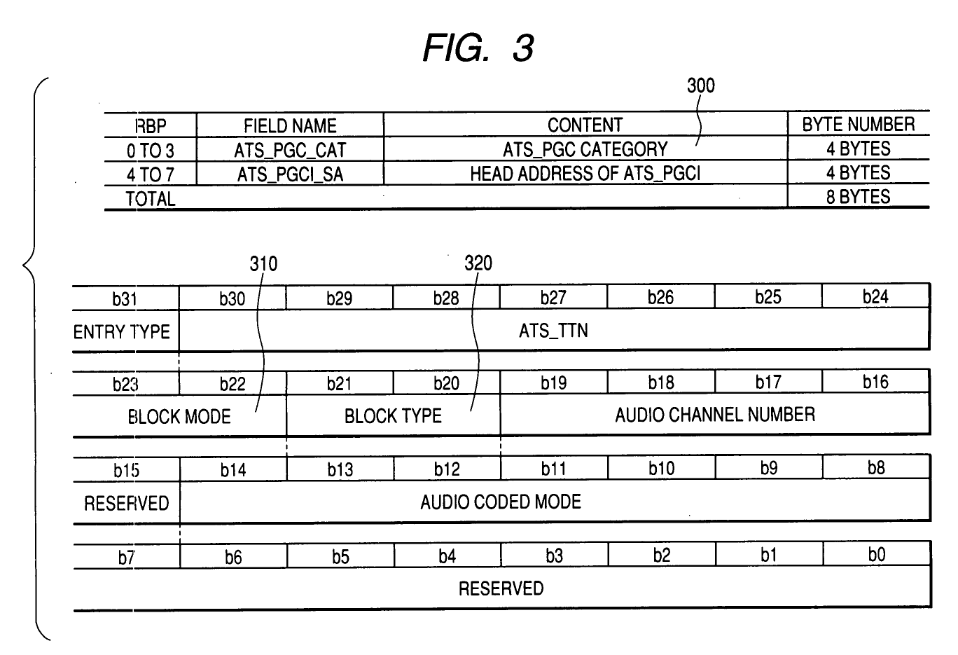

FIG. 3 is a diagram for representing a detailed data structure as to the ATS_PGCI_SRP 210. Such information that two sorts of audio data are present whose contents are identical to each other and whose specifications are different from each other is stored in both a block mode 310 and a block type 320 within a ATS_PGC_CAT (ATS_PGC category) 300.

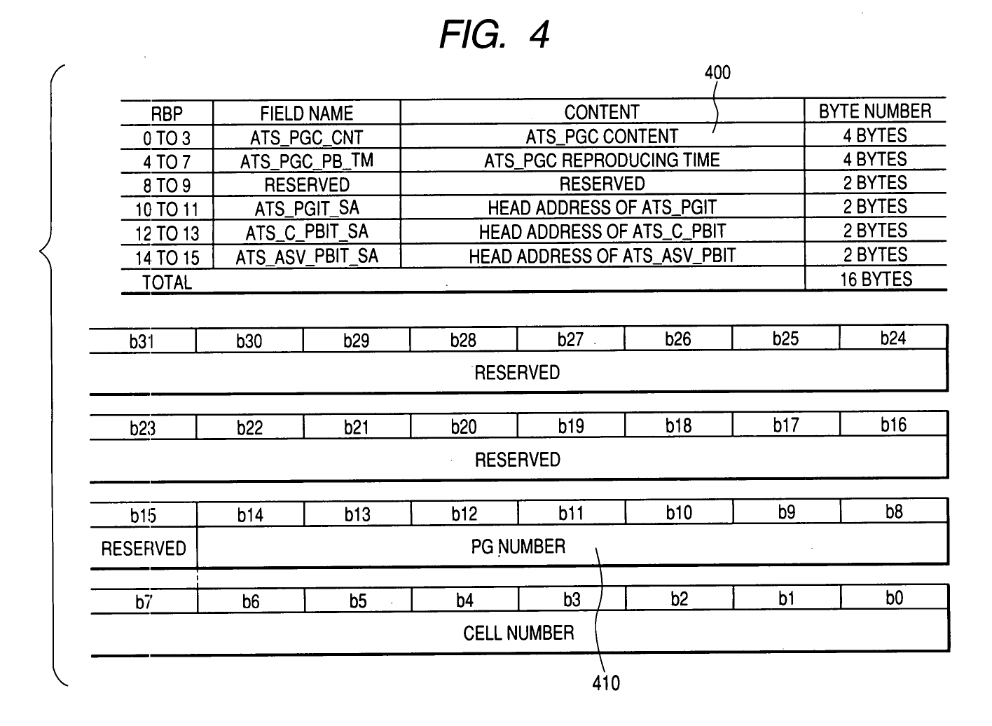

FIG. 4 is a diagram for representing a detailed data structure as to the ATS_PGCI_GI 220. Such information that a single audio data has been constituted by a plurality of tracks is recorded in a PG number 410 within an ATS_PGC_CNT (ATS_PGC content) 400.

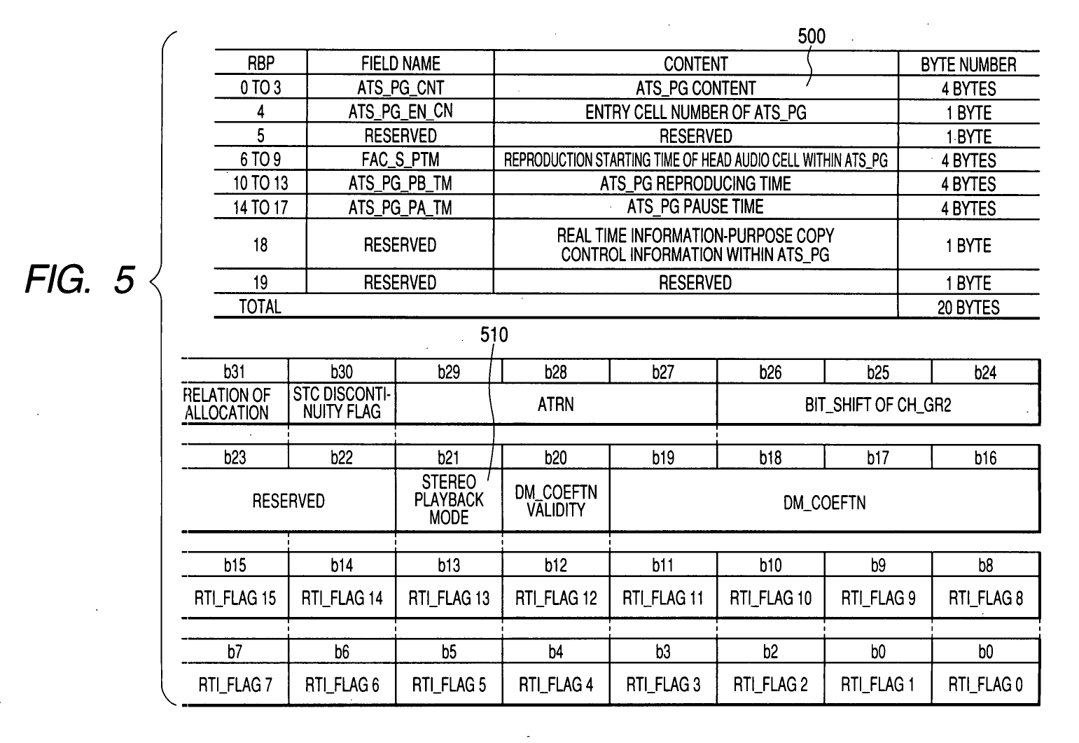

FIG. 5 is a diagram for representing a detailed data structure as to the ATS_PGI 2300. Such information for indicating as to whether or not a stereophonic reproduction is prohibited is recorded in a Stereo play back mode 510 within an ATS_PG_CNT (ATS_PG content) 500.

Next, a concrete explanation is made of the management information which is produced based upon the audio data recorded on the optical disk.

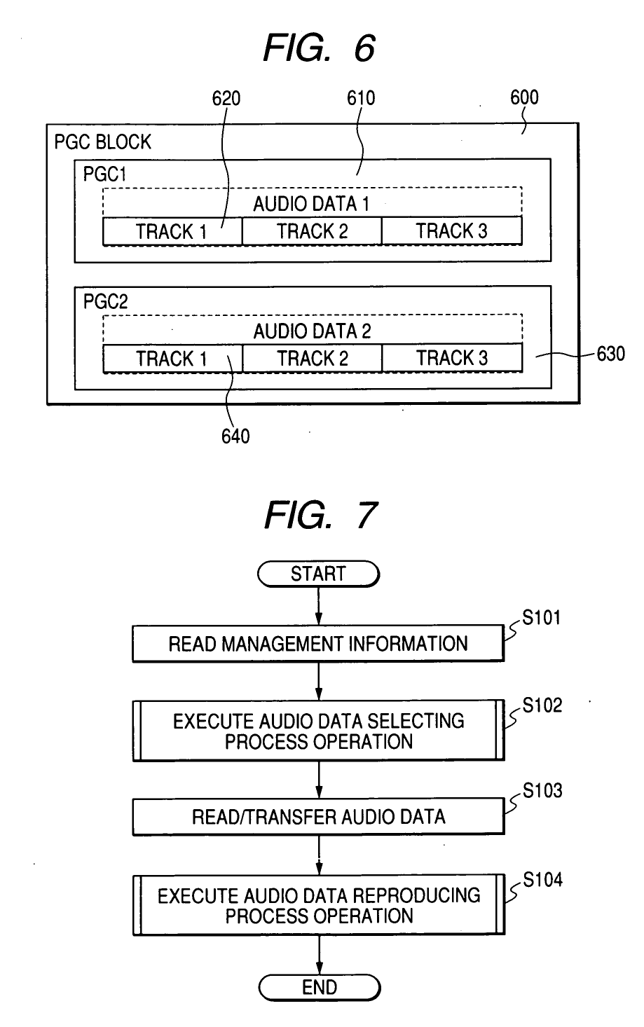

FIG. 6 is a diagram for indicating logic formats as to the audio data recorded on the optical disk. As indicated in this drawing, a PGCBlock 600 has such a structure containing two sorts of audio data (namely, PGC 610 and PGC 630) whose contents are identical to each other and whose specifications are different from each other. As a consequence, in this case, such information for indicating such a PGCBlock that the audio data PGC 610 and PGC 630 are present is recorded in a block mode 310 area for indicating as to whether or not the PGCBlock is present. Also, since three tracks are present within the audio data PGC 610 and PGC 630, “3” is recorded in the PG number 410 which records the number of tracks present in the PGC. Furthermore, a difference between the specifications of the audio data PGC 610 and PGC 630 is recorded in a block type 320.

It should also be understood that audio data has not been actually recorded in such a structure as shown in FIG. 6, but a plurality of information recorded in physical sections are combined with each other, and the above-described management information has been recorded in order that the combined information may be reproduced in the logic structure shown in FIG. 6. It should also be noted that the known physical structure as to the physical format of the audio data may be employed, and therefore, detailed explanations thereof are omitted.

Next, a description is made of reproducing operations of the optical disk reproducing apparatus with employment of the above-described arrangement.

FIG. 7 is a flow chart for describing reproducing sequential operations executed by the optical disk reproducing apparatus according to the embodiment mode 1 of the present invention. When the optical disk reproducing apparatus commences to reproduce the optical disk 100, the reading means 110 reads out the management information recorded on the optical disk 100, and then, stores the read management information into both the audio attribute information-purpose memory 150 and the audio data management information-purpose memory 160, which are employed in the management information storage means 120 (step S101).

Next, the reproducing audio data control means 140 selects such an audio data which is reproduced in accordance with a reproducing audio data selecting sequential (will be explained later) based upon the information recorded in the ATS_PGC_CAT 300 area (step S102). The reproducing audio data control means 140 reads out the selected audio data via the reading means 110, and then, transfers the read audio data to the audio reproducing means 130 (step Si 03). The transferred audio data is reproduced by the audio reproducing means 130 (step S104).

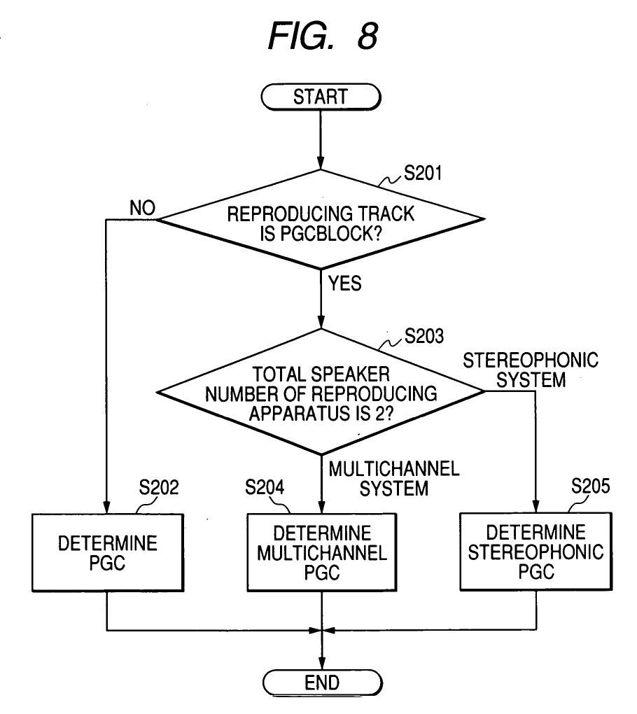

FIG. 8 is a flow chart for describing a selecting sequence of audio data which is reproduced. The reproducing audio data control means 140 judges as to whether or not a track which will be subsequently reproduced corresponds to PGCBlock by referring to the information recorded in the block mode 310 area (step S201). In the case that the track which will be subsequently reproduced is not PGCBlock, the reproducing audio data control means 140 determines that this track corresponds to PGC (step S202). On the other hand, in such a case that the track which will be subsequently reproduced corresponds to PGCBlock, the reproducing audio data control means 140 judges a total number of speakers which are connected to the optical disk reproducing apparatus (step S203). In the case that the judged speaker quantity corresponds to the multichannel system, the reproducing audio data control means 140 determines a multichannel-purpose PGC (step S204). Also, in the case that the judged speaker quantity corresponds to the stereophonic system, the reproducing audio data control means 140 determines a stereophonic-purpose PGC (step S205).

Next, a description is made of reproduction switching operations of the optical disk reproducing apparatus with employment of the above-described arrangement.

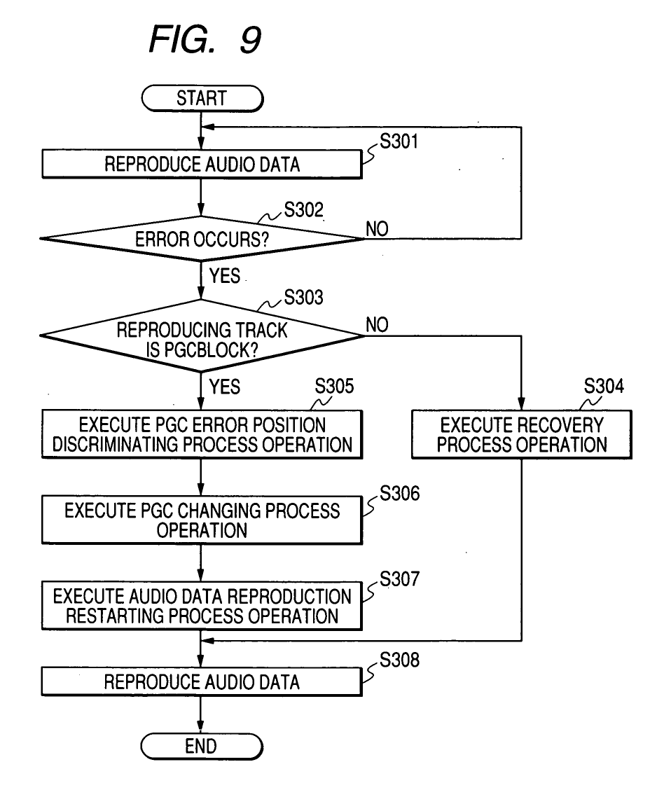

FIG. 9 is a flow chart for describing reproduction switching sequential operations executed by the optical disk reproducing apparatus according to the embodiment mode 1 of the present invention. While the audio data is reproduced (step S301), the reproduction switching means 141 of the reproduction audio data control means 140 continuously monitors a physical error, a logic decode error, and the like of the optical disk 100 (step S302). In the case that an error is detected while the audio data is reproduced, the reproduction switching means 141 judges as to whether or not the audio data during reproduction corresponds to PGCBlock (step S303).

In the case that the audio data under reproduction does not correspond to PGCBlock, the reproduction switching means 141 executes a normal error recovery process operation, and then, the process operation is accomplished (step S304). On the other hand, in the case that the audio data under reproduction correspond to PGCBlock, the reproduction switching means 141 identifies an error position (step 305), since there are such audio data whose contents are identical to each other, and whose specifications are different from each other (namely, different reproducing systems), and then, executes such a process operation that the PGC which is presently reproduced is changed into such a PGC having a different specification for defining this audio data (step S306). For example, in an optical disk having the logic structure shown in FIG. 6, in such a case that an error is detected while the PGC 610 is reproduced, this PGC 610 under reproduction is changed into the PGC 630, and also, in such a case that an error is detected while the PGC 630 is reproduced, this PGC 630 under reproduction is changed into the PGC 610. Furthermore, the reproduction switching means 141 performs a switching process operation is order to restart a reproducing operation in the changed PGC (step S307). Subsequently, the reproducing audio data control means 140 causes the audio reproducing means 130 to execute the normal audio data reproducing process operation in the changed PGC (step S308).

In accordance with the above-described sequential operations, the occurrence of the reproduction error as to the selected data is detected, and then, the reproducing operation of the selected data is changed into the reproducing operation for the data whose reproducing system is different from that of the selected data. As a result, since the reproduction error occurs, the reproduction of the audio data was conventionally interrupted and/or the audio data could not be reproduced. However, even such an audio data portion can be continuously reproduced.

### Embodiment Mode 2

Next, an optical disk reproducing apparatus according to an embodiment mode 2 of the present invention will now be described. Comparing with the embodiment mode 1, the optical disk reproducing apparatus of the embodiment mode 2 owns such a different technical idea. That is, after an error occurrence position has passed, the present reproducing operation is recovered to a reproducing operation for such an audio data having a specification before switching operation was carried out (namely, reproducing system). It should be noted that since an internal arrangement of the above-described optical disk reproducing apparatus of the embodiment mode 2 is the same as that of the embodiment mode 1, explanations thereof are omitted. Also, since reproducing sequential operations of the optical disk reproducing apparatus according to the embodiment mode 2 are also identical to those of the embodiment mode 1, explanations thereof are omitted.

Next, a description is made of reproduction switching operations executed by the optical disk reproducing operation according to the embodiment mode 2.

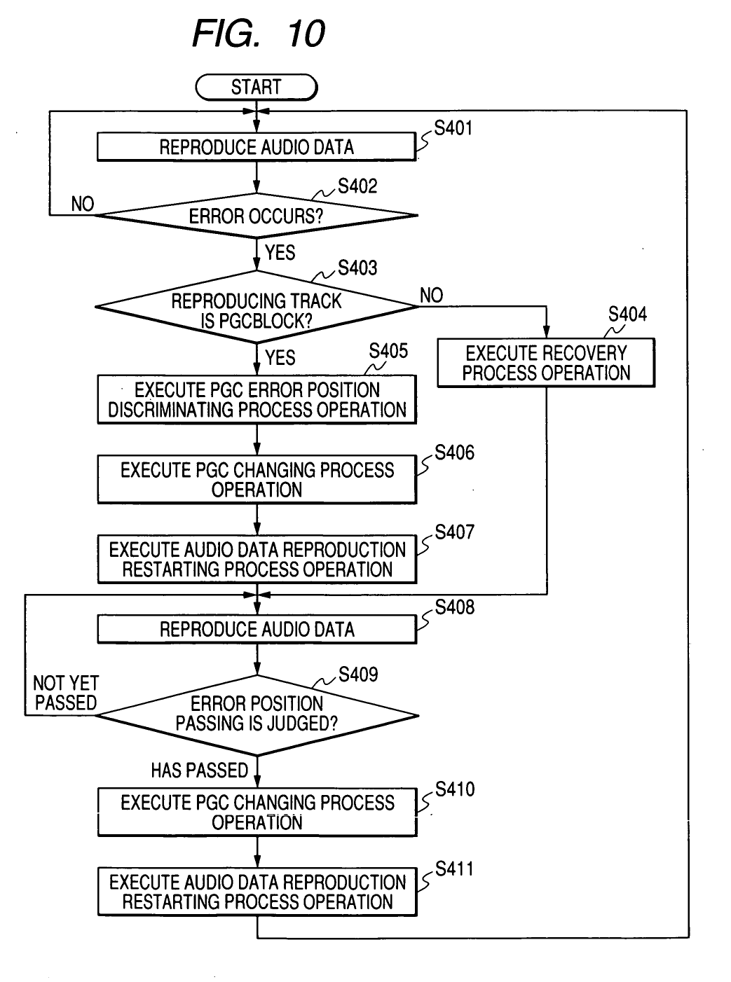

FIG. 10 is a flow chart for describing reproduction switching sequential operations of the optical disk reproducing apparatus according to the embodiment mode 2 of the present invention. Since sequential operations defined from a step S401 up to a step S408 are similar to the reproduction switching sequential operations (step S301 to step S308 in flow chart of FIG. 9) executed in the optical disk reproducing apparatus of the embodiment mode 1, explanations thereof are omitted.

When a reproducing operation is commenced as to the audio data recorded in another specification from a disk portion where an error is detected (step S408), the reproduction switching means 141 judges as to whether or not the reproducing operation has passed through the disk portion corresponding to the error portion (step S409). In such a case that the reproducing operation has passed through the disk portion corresponding to the error portion, even if the reproducing operation is returned to the original PGC, there is no problem in the reproducing operation. As a result, the reproduction switching means 141 changes the reproducing operation to the original PGC (step S410), and performs such a processing operation for restarting the reproducing operation of the original PGC (step 411).

Thereafter, the process operation is returned to the sequence of the previous step S401 in which a reproducing operation of the audio data is carried out by the audio reproducing means 130. It should also be understood that when an error portion is again detected while the subsequent reproducing operation is carried out, the reproduction switching means 141 again executes a switching operation of a reproducing operation in accordance with the sequential operations after the above-described step S402.

In accordance with the above-explained sequential operations, even when the audio data of the present specification is switched to the audio data of another specification and this switched audio data is reproduced, the reproducing operation for the original audio data is recovered after the error portion has passed. As a consequence, the optical disk can be reproduced based upon the audio data which is optimized to the audio system being used by the user except for the error portion without interrupting the reproducing operation.

### Embodiment Mode 3

Next, an optical disk reproducing apparatus according to an embodiment mode 3 of the present invention will now be described. Comparing with the embodiment mode 2, the optical disk reproducing apparatus of the embodiment mode 3 owns such a different technical idea. That is, after a track containing an error portion has been completed, the reproducing operation of the present audio data is switched to the reproducing operation of such an audio data which was reproduced before the switching operation was carried out. It should be noted that since an internal arrangement and reproduction sequential operations of the above-described optical disk reproducing apparatus of the embodiment mode 3 are the same as that of the embodiment mode 1 similar to the embodiment mode 2, explanations thereof are omitted.

Next, a description is made of reproduction switching operations executed by the optical disk reproducing operation according to the embodiment mode 3.

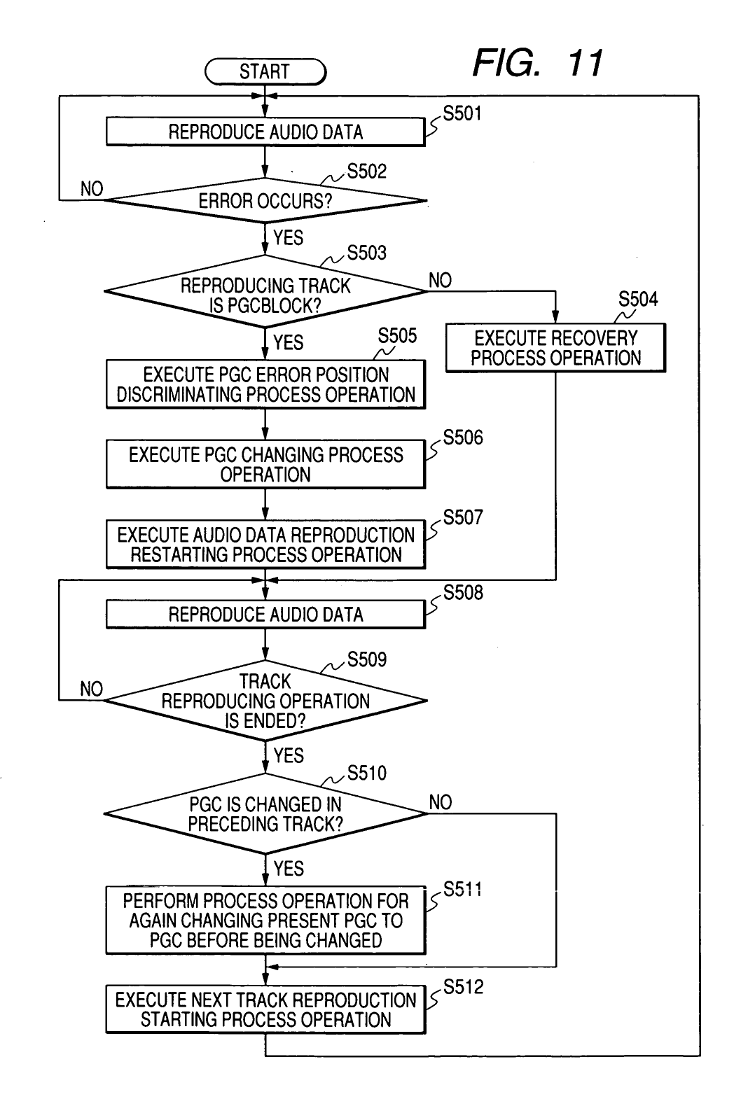

FIG. 11 is a flow chart for describing reproduction switching sequential operations of the optical disk reproducing apparatus according to the embodiment mode 3 of the present invention. Since sequential operations defined from a step S501 up to a step S508 are similar to the reproduction switching sequential operations (step S401 to step S408 in flow chart of FIG. 10) executed in the optical disk reproducing apparatus of the embodiment mode 2, explanations thereof are omitted.

When a reproducing operation is commenced as to the audio data recorded in another specification (another reproducing system) from a disk portion where an error is detected (step S508), the reproduction switching means 141 judges as to whether or not the reproducing operation of this track is accomplished (step S509). When the reproducing operation is accomplished, the reproduction switching means 141 judges as to whether or not PGC has been changed in the preceding track (step S510). In the case that PGC has been changed in the preceding track, the reproduction switching means 141 recovers PGC to such a PGC before being changed (step S511), and a reproduction starting process operation of the next track is carried out (step S512) Thereafter, the process operation is returned to the sequence of the previous step S501 in which a reproducing operation of the audio data is carried out by the audio reproducing means 130. It should also be understood that when an error portion is again detected while the subsequent reproducing operation is carried out, the reproduction switching means 141 again executes a switching operation of a reproducing operation in accordance with the sequential operations after the above-described step S502.

In accordance with the above-explained sequential operations, the reproducing operation of the present audio data is switched for such an audio data having another specification only in the track containing the error portion, and the reproducing operation for the original audio data is recovered in tracks other than the track containing the error portion. As a consequence, the optical disk can be reproduced based upon the audio data which is optimized to the audio system being used by the user except for the track containing the error portion without interrupting the reproducing operation.

It should also be noted that in this embodiment mode 3, while the switching operation of the reproducing operation is not carried out at the error portion, the reproducing operation may be alternatively carried out at a head portion of the track containing the error portion. That is to say, in such a case that a detection is made of such a fact that an error portion is contained within a track, the reproduction switching means 141 is returned back to a head portion of this track so as to switch the reproducing operations. If this alternative operation is employed, then, such a process operation may be omitted in which reproducing positions of the respective audio data on the same tracks are made coincident with each other.

### Embodiment Mode 4

Next, an optical disk reproducing apparatus according to an embodiment mode 4 of the present invention will now be described. Comparing with the embodiment mode 1, the optical disk reproducing apparatus of the embodiment mode 4 owns such a different technical idea. That is, such a process operation for performing a reproducing operation which is adapted to an audio system of a user is additionally provided in the case that the reproducing operation of the present audio data is switched to a reproducing operation of audio data recorded another specification (namely, another reproducing system). It should be noted that since an internal arrangement and reproducing sequential operations of the above-described optical disk reproducing apparatus of the embodiment mode 4 are the same as that of the embodiment mode 1, explanations thereof are omitted.

Next, a description is made of reproduction switching operations executed by the optical disk reproducing operation according to the embodiment mode 4.

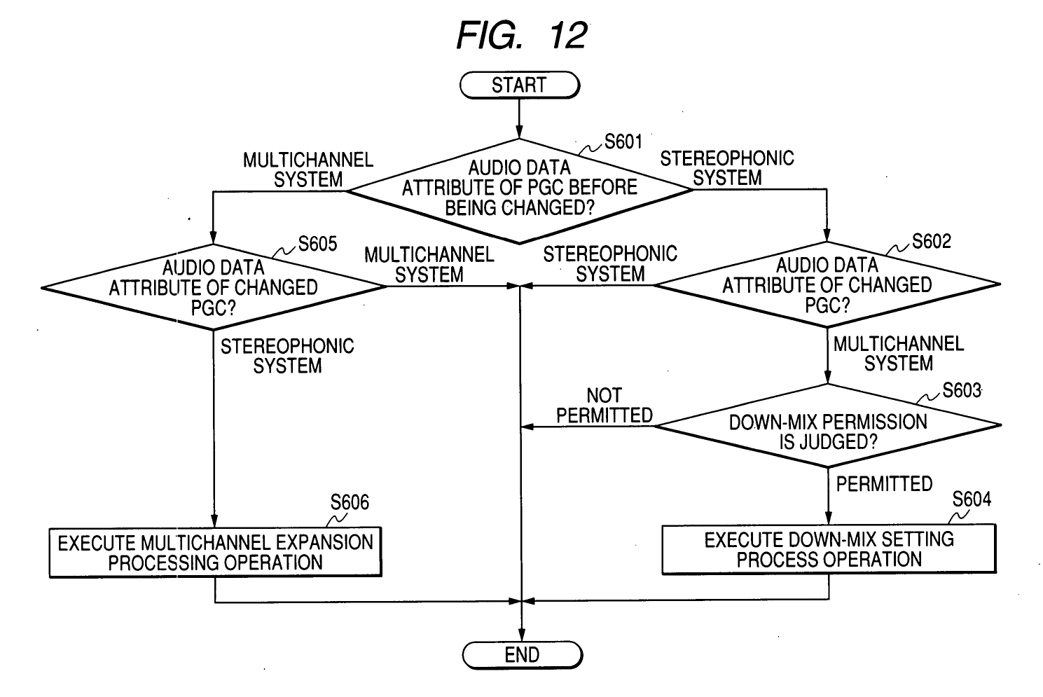

FIG. 12 is a flow chart for describing a sequential process operation for optimizing a reproducing operation of the optical disk reproducing apparatus according to the embodiment mode 4 of the present invention. This optimization process operation is executed while a PGC changing process operation (for instance, step S306 of flow chart of FIG. 9 in optical disk reproducing apparatus of embodiment mode 1) in a reproduction switching operation. Firstly, the reproduction switching means 141 discriminates an audio data attribute of PGC where an error happens to occur by referring to a block type 320 area of the management information (step S601). In such a case that the discriminated attribute corresponds to the stereophonic system, the reproduction switching means 141 subsequently refers to the block type 320 area so as to discriminate an audio data attribute of PGC which will be changed (step S602). In the case that the discriminated attribute corresponds to the multichannel system, the reproduction switching means 141 judges as to whether a down-mix setting process operation is permitted, or not permitted in Stereo playback mode 510 area (step S603). In the case that the down-mix setting process operation is permitted, the reproduction switching means 141 executes the down-mix setting process operation (step S604).

On the other hand, in the case that the audio data attribute of the PGC where the error happens to occur corresponds to the multichannel system, the reproduction switching means 141 discriminates an audio data attribute of PGC which will be changed by similarly referring to the block type 320 area (step S605). When the discriminated audio data attribute corresponds to the stereophonic system, the reproduction switching means 141 executes a multichannel expansion process operation (step S606).

In accordance with the above-described sequential operations, while the audio data is reproduced by the stereophonic reproducing apparatus, in such a case that the present reproducing operation for the stereophonic audio data is switched to the reproducing operation for the multichannel audio data, the down-mix setting process operation is carried out, whereas while the audio data is reproduced by the multichannel reproducing apparatus, in such a case that the present reproducing operation for the multichannel audio data is switched to the reproducing operation for the stereophonic audio data, the multichannel process operation is carried out, whereas while the multichannel expansion process operation is carried out. As a result, even when the audio data which is reproduced is switched in a half way, the audio data can be reproduced in such a reproduction mode which is more suitably fitted to the audio system of the user.

### Embodiment Mode 5

Next, an optical disk reproducing apparatus according to an embodiment mode 5 of the present invention will now be described. Comparing with the embodiment mode 1, the optical disk reproducing apparatus of the embodiment mode 5 owns such a different technical idea. That is, the user may set as to whether or not the reproducing operation for the present audio data is switched to a reproducing operation for audio data recorded by another specification (another reproducing system) when an error portion is detected in the present audio data, and further, when the reproducing operation is switched, such a display for indicating the switching operation of the reproduced data is notified. It should be noted that since an internal arrangement and a reproducing sequential operation of the above-described optical disk reproducing apparatus of the embodiment mode 5 are the same as that of the embodiment mode 1, explanations thereof are omitted.

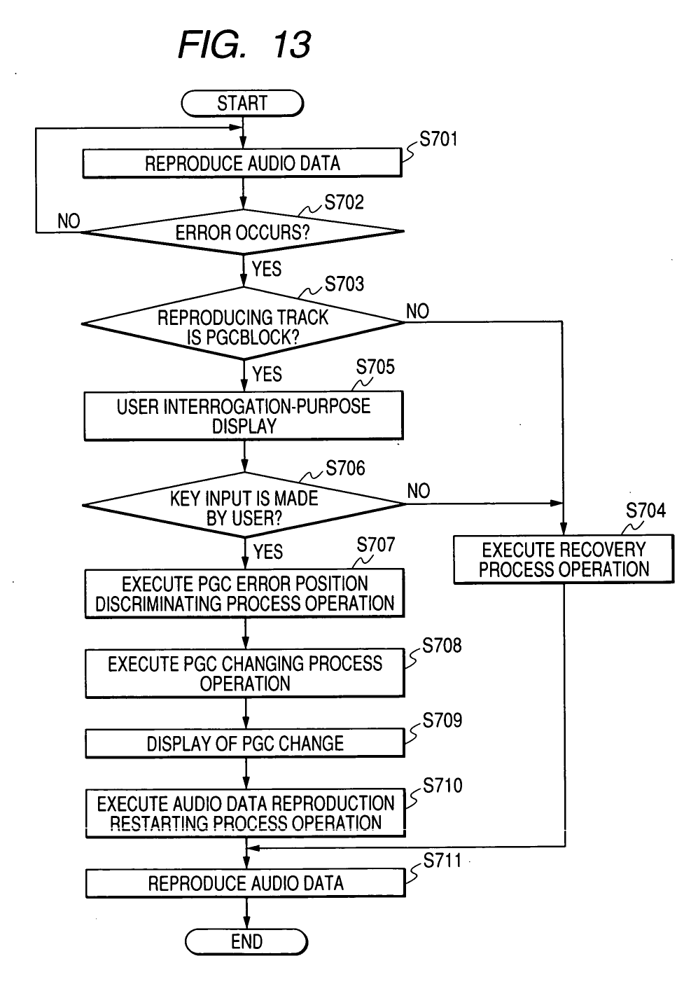

FIG. 13 is a flow chart for describing reproduction switching sequential operations of the optical disk reproducing apparatus according to the embodiment mode 5 of the present invention. Since sequential operations defined from a step S701 up to a step S704 are similar to the reproduction switching sequential operations (step S301 to step S304 in flow chart of FIG. 9) executed in the optical disk reproducing apparatus of the embodiment mode 1, explanations thereof are omitted.

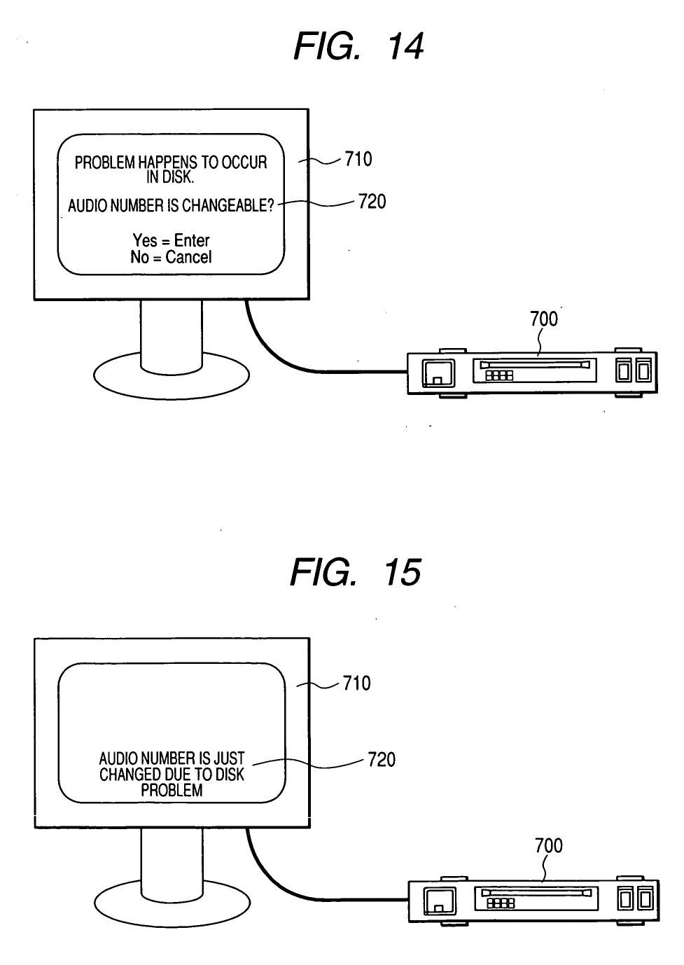

In the case of such a PGCBlock that audio data having the same contents, whose specifications are different from each other, are present (step S703), the reproduction switching means 141 displays such a message for interrogating as to whether or not a switching operation for audio data is carried out with respect to an external display means (not shown) (step S705). FIG. 14 is a schematic diagram for indicating a display example to a monitor 710 corresponding to the above-described external display means. In this drawing, a message 720 for interrogating as to whether or not the reproducing operation is switched is displayed on the monitor 710 which is connected to a main body 700 of the optical disk reproducing apparatus.

The reproduction switching means 141 waits for a response to the interrogation (step S706), and then, when the user answers that the reproducing operation is not switched, the process operation is advanced to a step S704 in which the reproduction switching means 141 executes the normal recovery process operation. On the other hand, when the user answers that the reproducing operation is switched (namely, permit switching operation), the reproduction switching means 141 discriminates an error position (step S707), and executes such a process operation that PGC which is presently reproduced is changed into PGC recorded by another specification (another reproducing system) (step S708). At the same time, the reproduction switching means 141 displays such a message that PGC has been changed with respect to an external display means (not shown) (step S709). FIG. 15 is a schematic diagram for indicating a display example to a monitor 710 corresponding to the above-described external display means. In this drawing, a message 730 for informing that the reproducing operation is switched is displayed on the monitor 710 which is connected to a main body 700 of the optical disk reproducing apparatus.

Furthermore, the reproduction switching means 141 executes a process operation for restarting that the changed PGC is reproduced (step S710). Subsequently, the reproducing audio data control means 140 causes the audio reproducing means 130 to execute the normal audio data reproducing process operation for the changed PGC (step S711).

In accordance with the above-explained sequential operations, since the user can set as to whether or not the reproducing operation is switched, the reproducing operation is automatically switched. As a result, it is possible to avoid that the user is confused. Also, since the switching operation of the reproduced data is notified, the user can recognize such a change that the reproducing sound quality is lowered which is caused by switching the reproducing operation. As a result, it is possible to avoid that the user is confused.

It should also be noted that in the above-explained embodiment mode 5, the interrogation as to whether or not the reproducing operation is switched is not made every time the error portion is produced, but may be alternatively omitted after a first answer issued from the user is received. In this alternative case, when the switching operation of the reproducing operation occurs, only a display of this indication may be made.

Also, although the above description has exemplified such a case that the optical disk in which the audio data are recorded on the different disk areas by differing the reproducing systems thereof is reproduced, a sort of data and a sort of disk are not limited only to the above-described sorts.

The present invention may have such an effect that the occurrence of the reproduction error as to the selected data is detected and the reproducing operation for the selected data is switched to the reproducing operation for the data whose reproducing system is different from the reproducing system of the selected data, so that the reproducing operation can be continuously carried out even in such a portion that the reproducing operation has been conventionally interrupted, or could not be conventionally performed due to the occurrence of the reproduction error. Therefore, the present invention is useful for the disk reproducing method, the control preprogram thereof, the recording medium, the disk reproducing apparatus, the optical disk-purpose signal processing circuit, and the like.

What is claimed is:

1. A disk reproducing method for selecting data reproduced in response to a reproduction environment from a disk in which data whose reproducing systems are different from each other have been recorded in different areas of the disk, comprising:
a reproduction switching step for detecting an occurrence of a reproduction error as to the selected data and for switching the reproducing operation for the selected data to a reproducing operation for data whose reproducing system is different from the reproducing system of the selected data.

2. The disk reproducing method according to claim 1, wherein:
the reproduction switching step detects passing of an occurring position of the reproduction error, and then switches the present reproducing operation to the reproducing operation for the data which was reproduced before the switching operation.

3. The disk reproducing methodas claimed in claim 1, wherein:
the reproduction switching step detects a completion of a reproducing operation of a track, and then switches the present reproducing operation to the reproducing operation for the data which was reproduced before the switching operation.

4. The disk reproducing method as claimed in claim 1 wherein:
the reproduction switching step detects a reproduction error as to selected stereophonic reproducing type data, and then switches the reproducing operation for the stereophonic reproducing type data into a reproducing operation for multichannel reproducing type data by way of a down-mix process operation.

5. The disk reproducing method as claimed in claim 1 wherein:
the reproduction switching step detects a reproduction error as to selected multichannel reproducing type data, and then switches the reproducing operation for the multichannel reproducing type data into a reproducing operation for stereophonic reproducing type data by way of a multichannel expansion process operation.

6. The disk reproducing method as claimed in claim 1, further comprising:
a step for notifying switching of reproduction data.

7. The disk reproducing method as claimed in claim 1, further comprising:
a step for permitting that reproduction data is switched by the reproduction switching step in response to an external instruction.

8. A control program of a disk reproducing apparatus for selecting data which is reproduced in response to a reproduction environment from a disk in which data whose reproducing systems are different from each other have been recorded in different areas of the disk, wherein:
the control program causes a computer to execute a reproduction switching step for detecting an occurrence of a reproduction error as to the selected data and for switching the reproducing operation for the selected data to a reproducing operation for data whose reproducing system is different from the reproducing system of the selected data.

9. The control program as claimed in claim 8, wherein:
the reproduction switching step detects passing of an occurring position of the reproduction error, and then switches the present reproducing operation to the reproducing operation for the data which was reproduced before the switching operation.

10. The control program as claimed in claim 8 wherein:
the reproduction switching step detects a completion of are producing operation of atrack, and then switches the present reproducing operation to the reproducing operation for the data which was reproduced before the switching operation.

11. The control program as claimed in claim 8 wherein:
the reproduction switching step detects a reproduction error as to selected stereophonic reproducing type data, and then switches the reproducing operation for the stereophonic reproducing type data into a reproducing operation for multichannel reproducing type data byway of a down-mix process operation.

12. The control program as claimed in claim 8 wherein:
the reproduction switching step detects a reproduction error as to selected multichannel reproducing type data, and then switches the reproducing operation for the multichannel reproducing type data into a reproducing operation for stereophonic reproducing type data by way of a multichannel expansion process operation.

13. The control program as claimed in claim 8, wherein:
the control program causes the computer to execute a step for notifying switching of reproduction data.

14. The control program as claimed in claim 8, wherein:
the control program causes the computer to execute a step for permitting that reproduction data is switched by the reproduction switching step in response to an external instruction.

15. A recording medium wherein:
the control program recited in claim 8 is recorded.

16. A disk reproducing apparatus wherein:
a memory for recording there in the control program recited in claim 8 is mounted.

17. An optical disk-purpose signal processing circuit for selecting data which is reproduced in response to a reproduction environment from a disk in which data whose reproducing systems are different from each other have been recorded in different areas of the disk, comprising:
reading means for reading data from the optical disk;
audio reproducing means for demodulating audio data from the data read by the reading means;
management information storage means for storing thereinto management information used to reproduce the data read by the reading means; and
reproducing data control means for controlling data which is reproduced; wherein:
the reproducing data control means is comprised of reproduction switching means for detecting an occurrence of a reproduction error as to the selected data and for switching the reproducing operation for the selected data to a reproducing operation for data whose reproducing system is different from the reproducing system of the selected data.

18. An optical disk-purpose signal processing circuit as claimed in claim 17 wherein:
the reproduction switching means detects passing of an occurring position of the reproduction error, and then switches the present reproducing operation to the reproducing operation for the data which was reproduced before the switching operation.

19. The optical disk-purpose signal processing circuit as claimed in claim 17 wherein:
the reproduction switching means detects a completion of a reproducing operation of a track, and then switches the present reproducing operation to the reproducing operation for the data which was reproduced before the switching operation.

20. The optical disk-purpose signal processing circuit as claimed in claim 17, wherein:
the reproduction switching means detects a reproduction error as to selected stereophonic reproducing type data, and then switches the reproducing operation for the stereophonic reproducing type data into a reproducing operation for multichannel reproducing type data by way of a down-mix process operation.

21. The optical disk-purpose signal processing circuit as claimed in claim 17 wherein:
the reproduction switching means detects a reproduction error as to selected multichannel reproducing type data, and then switches the reproducing operation for the multichannel reproducing type data into a reproducing operation for stereophonic reproducing type data by way of a multichannel expansion process operation.

22. The optical disk-purpose signal processing circuit as claimed in claim 17, further comprising:
notification means for notifying switching of reproduction data.

23. The optical disk-purpose signal processing circuit as claimed in claim 17, further comprising:
permission means for permitting that reproduction data is switched by the reproduction switching means in response to an external instruction.

24. The disk reproducing method as claimed in claim 1, wherein:
the data corresponds to audio data having a data structure standardized by the DVD-Audio specification.
